(19) United States
(12) Patent Application Publication
(10) Pub. No.: US 2017/0031947 A1
(43) Pub. Date: Feb. 2, 2017

(54) SYSTEMS AND METHODS FOR INFORMATION PRESENTATION AND COLLABORATION

(71) Applicant: Promethean Limited, Blackburn (GB)

(72) Inventor: Sriraman Venkataraman, Atlanta, GA (US)

(21) Appl. No.: 15/222,231

(22) Filed: Jul. 28, 2016

Related U.S. Application Data
(60) Provisional application No. 62/197,961, filed on Jul. 28, 2015.

(51) Int. Cl. G06F 17/30; G06F 3/0488; H04L 29/06; G06F 3/0482; G06F 17/24

(52) U.S. Cl. CPC G06F 17/30165; G06F 3/0482; G06F 17/241; H04L 65/403; G06F 3/0488

(57) ABSTRACT

A system and method is adapted for allowing a user to display data on a display and to share one or more images of the displayed data with one or more users. The system includes a display and a single computer that generates a tool bar that is displayed on the display. The tool bar allows a user to annotate, capture an image, open a web browser, receive a notification when third party computers are coupled to the computer, and connect the computer to a cloud based service. The system receives a request to open a data file, opens the data file, and displays at least a portion of the data file on the display. The system also receives a request to duplicate (i.e., take a screenshot) of the display to store in memory, transmit to one or more remote computing devices, create a presentation, etc.

### CLAIM OF PRIORITY

This application claims priority to U.S. Provisional Patent Application No. 62/197,961, which was filed Jul. 28, 2015, and entitled “Systems and Methods for Information Presentation and Collaboration,” the entire disclosure of which is incorporated by reference herein in its entirety.

### INCORPORATION BY REFERENCE

This application incorporates by reference in its entirety, U.S. Published Patent Application No. 2015/0121231, published Apr. 30, 2015, entitled “Systems and Methods for Interactively Presenting a Presentation to Viewers.”

### BACKGROUND

Presentation systems generally enable a user to create a presentation using a slide presentation software package and display the presentation (e.g., as a slideshow) as series of pre-set (e.g., static) slides to one or more viewers or participants. While such presentation systems may be useful, the presenter may desire a more dynamic way to display the presentation such as by pushing different parts of the information out to subgroups of viewers. Moreover, presentation systems require that the presentation be formed in a certain file format. Thus, presentation systems do not allow a user to present information organized in disparate file formats.

Moreover, establishments typically have multiple networks—a first for allowing employees to access the company local area network and the second for allowing guests to gain access to the internet. This type of setup is similar to local area networks found in schools. For example, in many schools a first teachers' local area network is available for teachers and administrators to connect to in order to access school specific applications and the internet and a second students' local area network is available for the students to connect to student specific applications and the internet.

The use of multiple networks can make collaborating between groups of individuals very difficult. For example, when a group of individuals are engaged in a collaborative presentation, some of the individuals in the group may be connected to the first network while others in the group may be connected to the second network. Current mirroring systems allow a user to connect a mobile device such as a mobile phone or a remote computing device to a remote display when connecting to a network. These systems allow the user to mirror the content from the mobile computing device onto the remote display so that others may also view the content. These systems require the user to connect to a mirroring device such as Apple TV® or Chromecast® that connects to the same network to which the user's device is connected. However, when a second user attempts to connect to the mirroring device, the first user is kicked off and the second user is then able to control the content that is displayed from the second user's mobile device. Accordingly, there is currently a need for improved systems and methods for mirroring content from multiple users over multiple networks to allow various groups of users to share the same remote display.

### SUMMARY OF THE VARIOUS EMBODIMENTS

In general, in various embodiments, a non-transient computer readable medium containing program instructions is adapted for causing a single computer to perform a method of generating a tool bar that is displayed on a display operatively coupled to the single computer, where the tool bar comprises buttons that allow a user to select functionality selected from a group consisting of: (1) annotating on the display; (2) capturing an image of the display; (3) opening a web browser; (4) notifying a user of the single computer of third party remote computing devices coupled to the single computer; and (5) allowing a user of the single computer to operatively connect the single computer to an account associated with the user on a cloud based service. The single computer performs the method of receiving a request to open a data file. At least partially in response to receiving the request to open the data file, the single computer performs the method of opening the data file. The single computer further performs the method of displaying at least a portion of the data in the data file on the display and receiving a request to create a duplicate of the at least a portion of the data in the data file that is displayed on the display. At least partially in response to receiving the request to create an image, the single computer performs the method of creating an image of the at least a portion of the data. The single computer further performs the method of storing the image in memory.

In general, in various embodiments, a system is adapted for allowing a user to display data on a display and to share one or more images of the displayed data with one or more users. The system comprises: (1) a single computer having one or more processors; (2) a display operatively coupled to the single computer; and (3) memory operatively coupled to the one or more processors. The single computer is configured for receiving a request to open a data file. At least partially in response to receiving the request to open a data file, the single computer opens the data file. The single computer is further configured for displaying at least a portion of the data in the data file on the display and receiving a request to create a duplicate of the at least a portion of the data in the data file that is displayed on the display. At least partially in response to receiving the request to create an image, the single computer is configured for creating an image of the at least a portion of the data. The single computer is further configured for receiving a request to transmit the image to one or more remote computing devices operatively coupled with the single computer. At least partially in response to receiving the request to transmit the image to the one or more remote computing devices, the single computer transmits the image to the one or more remote computing devices during displaying the at least a portion of the data in the date file on the display.

According to various embodiments, a method is adapted for allowing a user to display data on a display and to share one or more images of the displayed data with one or more users. The system comprises generating a tool bar that is displayed on a display operatively coupled to a single computer. The tool bar comprises buttons that allow a user to select functionality selected from a group consisting of: (1) annotating on the display; (2) capturing an image of the display; (3) opening a web browser; (4) notifying a user of the single computer of third party remote computing devices coupled to the single computer; and (5) allowing a user of the single computer to operatively connect the single computer to an account associated with the user on a cloud based service. The system further comprises receiving a request to open a data file. At least partially in response to receiving the request to open a data file, the system opens the data file and displays at least a first portion of the data in the data file on the display. The system receives a request to create a first image of the at least a first portion of the data in the data file that is displayed on the display. At least partially in response to receiving the request to create a first image, the system creates a first image of the at least a first portion of the data. The system further comprises displaying at least a second portion of the data in the data file on the display. The system receives a request to create a second image of the at least a second portion of the data in the data file that is displayed on the display. At least partially in response to receiving the request to create a second image, the system creates a second image of the at least a second portion of the data. The system further comprises creating a presentation that incorporates the first image and the second image.

### BRIEF DESCRIPTION OF THE DRAWINGS

Various embodiments of a multi-network mirroring systems and methods are described below. In the course of this description, reference will be made to the accompanying drawings, which are not necessarily drawn to scale and wherein:

FIG. 1A is a block diagram of a multi-network mirroring system in accordance with an embodiment of the present system;

FIG. 1B is a block diagram of a multi-network mirroring system according to an alternate embodiment;

FIG. 1C is a block diagram of a multi-network mirroring collaborative system according to an alternate embodiment;

FIG. 1D is a block diagram of a collaborative system according to an alternate embodiment;

FIG. 2 is a block diagram of a computing device for use in the multi-network communication box of FIG. 1;

FIG. 3 is a block diagram of the multi-network communication box of FIG. 1;

FIG. 4 illustrates a flowchart that generally illustrates various steps executed by a multi-network mirroring module according to a particular embodiment;

FIG. 5 illustrates a flowchart that generally illustrates various steps executed by an access point mirroring module according to a particular embodiment;

FIG. 6 illustrates a flowchart that generally illustrates various steps executed by a presentation and collaboration module according to a particular embodiment;

FIGS. 7-9B illustrate an exemplary multi-network mirroring system according to various embodiments.

### DETAILED DESCRIPTION OF SOME EMBODIMENTS

Various embodiments will now be described more fully hereinafter with reference to the accompanying drawings. It should be understood that the invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Overview

A system and method is adapted for allowing a user to display data on a display and to share one or more images of the displayed data with one or more users. The system includes a display and a single computer that generates a tool bar that is displayed on the display. The tool bar allows a user to annotate, capture an image, open a web browser, receive a notification when third party computers are coupled to the computer, and connect the computer to a cloud based service that allows the user to push an editable slide or an image of data to various connected users. The system receives a request to open a data file, opens the data file, and displays at least a portion of the data file on the display. The system also receives a request to duplicate (i.e., take a screenshot) of the display to store in memory, transmit to one or more remote computing devices operatively coupled with the single computer while displaying the at least a portion of the data file on the display, create a presentation from one or more screenshots, etc.

In general, the system and method, according to various embodiments, may also be adapted for mirroring information from multiple remote computing devices onto a display using multiple local area networks. The system allows one or more users to display content from one or more remote computing devices simultaneously on the display. In various embodiments, the display is an interactive display that allows the user to annotate and comment through a transparent layer formed over the displayed content. The system may, in various embodiments, receive mirroring content from a first remote computing device that is connected to a first network such as the user's home network. The system may also receive mirroring content from a second remote computing device that is connected to a second network such as the user's guest network. The system may then mirror the content from the first remote computing device and mirror the content from the second remote computing device onto an interactive display such as a touch-enabled whiteboard or display. For example, in a classroom setting, the teacher can be connected to a teachers' local area network while the students are connected to a students' local area network. Through the use of the system, both the teacher and one or more students may mirror the information on a display for their mobile computing device onto a main interactive display that is in the classroom. Mirroring of the information for the teacher and/or one or more students may be displayed simultaneously on the interactive display. In this way, the students and teacher may collaborate while connected to different local area networks.

In various embodiments, the system includes a multi-network communication box that enables multiple users on multiple networks to mirror content onto a single display. The multi-network communication box includes one or more communication devices such as a network card, Wi-Fi device, Ethernet port, etc. The one or more communication devices are enabled to each connect to a different network (e.g., wired or wireless). The multi-network communication box also includes a graphics card for receiving graphic media to display on the interactive display. In various embodiments, the multi-network communication box includes ram memory and storage memory. In particular embodiments, the multi-network communication box also includes one or more output ports and one or more input ports for transmitting and receiving content from and to an interactive display.

Because the multi-network communication box is able to connect to multiple networks, companies are able to provide guests with access to a guest network rather than allowing guests or non-employees to connect to the company's corporate network. The multi-network communication box also allows schools to provide students access to a student network without providing them access to a teacher's network in order to collaborate with a teacher and other students while in the classroom. Thus, the system allows groups of users to connect to different networks while still collaborating on a central interactive display.

### Exemplary Technical Platforms

As will be appreciated by one skilled in the relevant field, the present systems and methods may be, for example, embodied as a computer system, a method, or a computer program product. Accordingly, various embodiments may be entirely hardware or a combination of hardware and software. Furthermore, particular embodiments may take the form of a computer program product stored on a computer-readable storage medium having computer-readable instructions (e.g., software) embodied in the storage medium. Various embodiments may also take the form of Internet-implemented computer software. Any suitable computer-readable storage medium may be utilized including, for example, hard disks, thumb drives, compact disks, DVDs, optical storage devices, and/or magnetic storage devices.

Various embodiments are described below with reference to block diagram and flowchart illustrations of methods, apparatuses, (e.g., systems), and computer program products. It should be understood that each block of the block diagrams and flowchart illustrations, and combinations of blocks in the block diagrams and flowchart illustrations, respectively, can be implemented by a computer executing computer program instructions. These computer program instructions may be loaded onto a general purpose computer, a special purpose computer, or other programmable data processing apparatus that can direct a computer or other programmable data processing apparatus to function in a particular manner such that the instructions stored in the computer-readable memory produce an article of manufacture that is configured for implementing the functions specified in the flowchart block or blocks.

The computer instructions may execute entirely on the user's computer, partly on the user's computer, as a stand-alone software package, partly on a user's computer and partly on a remote computer, or entirely on the remote computer or server. In the latter scenario, the remote computer may be connected to the user's computer through any suitable type of network, including but not limited to: (1) a local area network (LAN); (2) a wide area network (WAN); and/or (3) a cellular network. It should be understood that a particular computer's connection to the network may be made via an external computer (for example, by connecting to the Internet via a “hotspot” provided by a portable wireless device).

The computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer-implemented process (e.g., method) such that the instructions that execute on the computer or other programmable apparatus provide steps for implementing the functions specified in the flowchart block or blocks.

Example System Architecture

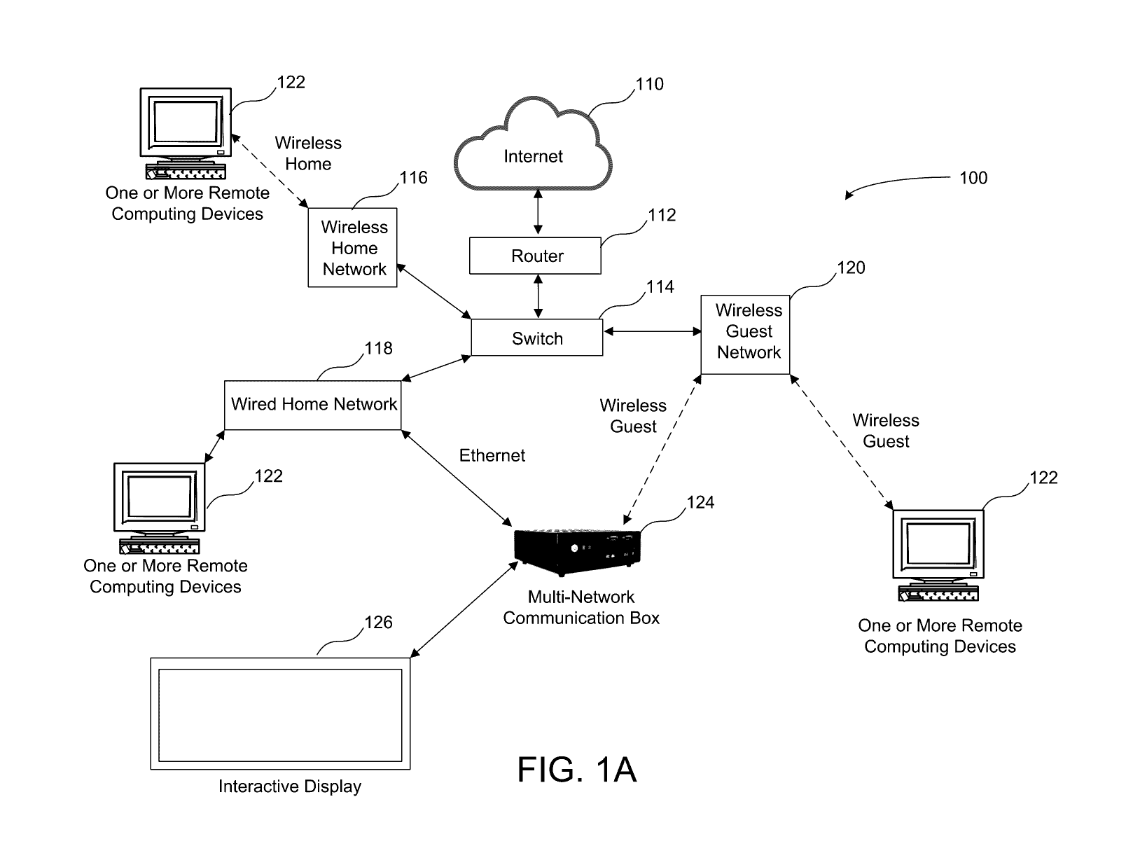

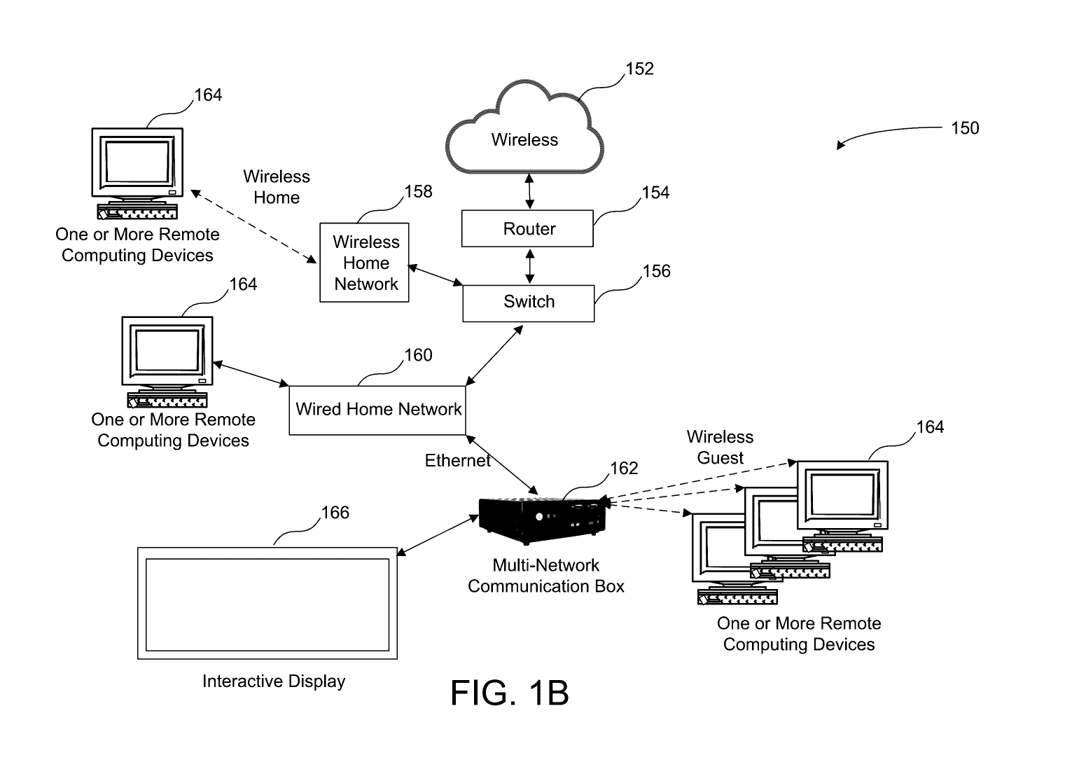

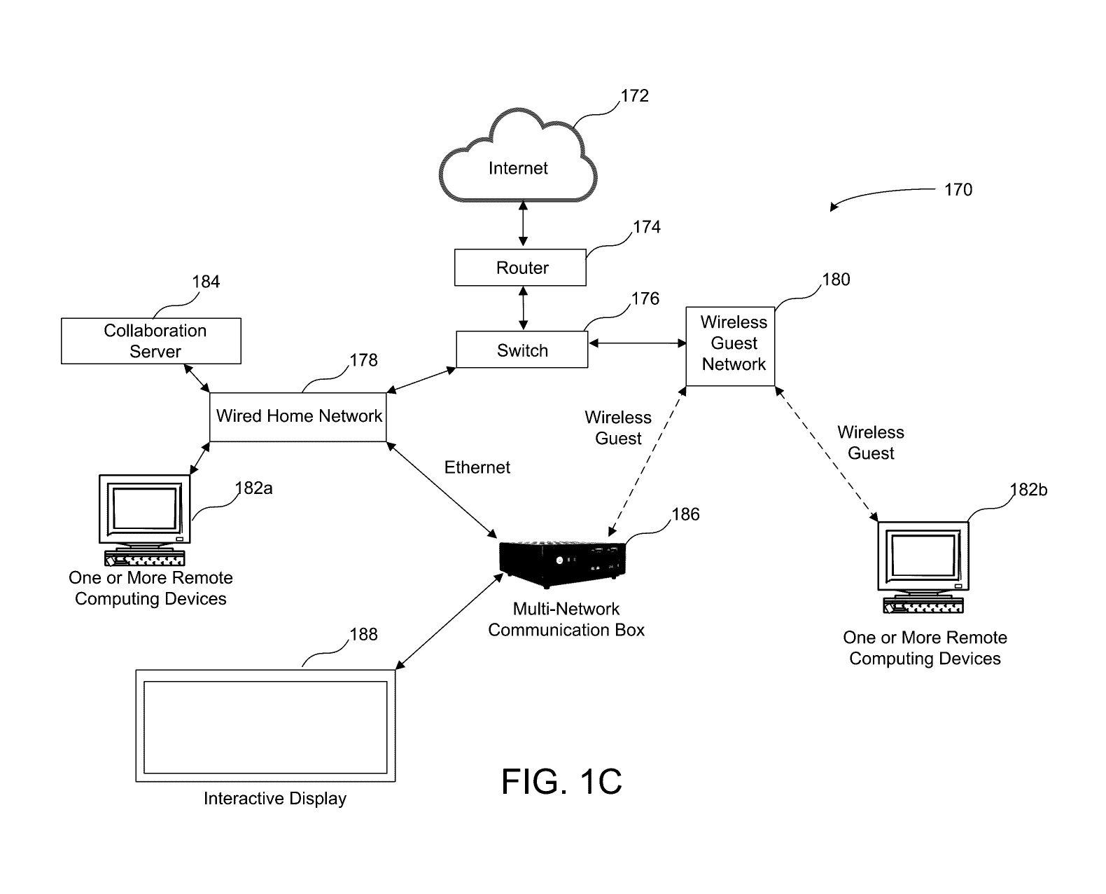

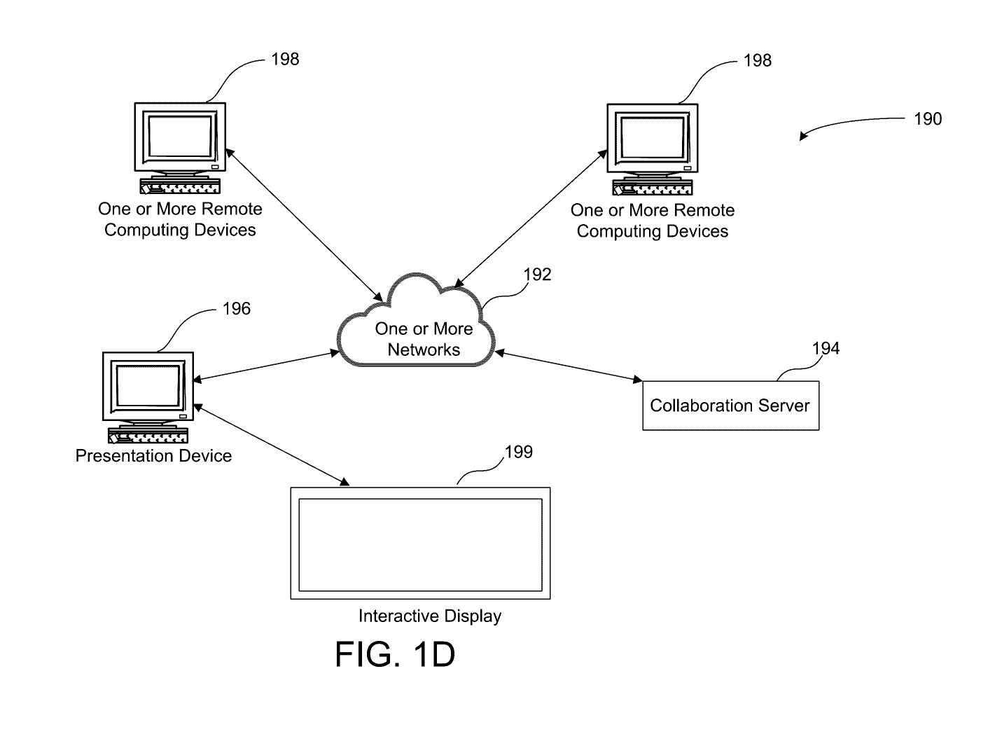

FIG. 1A is a block diagram of a multi-network mirroring system 100 according to particular embodiments. As may be understood from this figure, the multi-network mirroring system 100 includes Internet 110, a router 112, and a switch 114. The switch 114 may be operatively coupled to a wireless home network 116 (e.g., a corporate network, a teachers' network, etc.), a wired home network 118 (e.g., a corporate network, a teachers' network, etc.), and/or a wireless guest network 120 (e.g., a business guest network, a students' network, etc.) such that these networks may access the Internet 110. The networks 116, 118, 120 may include any of a variety of types of wired or wireless computer networks such as the Internet (or other WAN), a private intranet, a mesh network, a public switch telephone network (PSTN), or any other type of network (e.g., a network that uses Bluetooth, beacon communication technologies, and/or near field communications to facilitate communication between computing devices). In various embodiments, one or more remote computing devices 122 may be operatively coupled to any one of the wireless home network 116, the wired home network 118, or the wireless guest network 120. The communication link between the one or more remote computing devices 122 and the wired home network 118 may be, for example, implemented via an Ethernet connection. The communication link between the one or more remote computing devices 122 and the wireless home network 116 or the wireless guest network 120 may be, for example, implemented via a wireless connection (e.g., Wi-Fi, etc.).

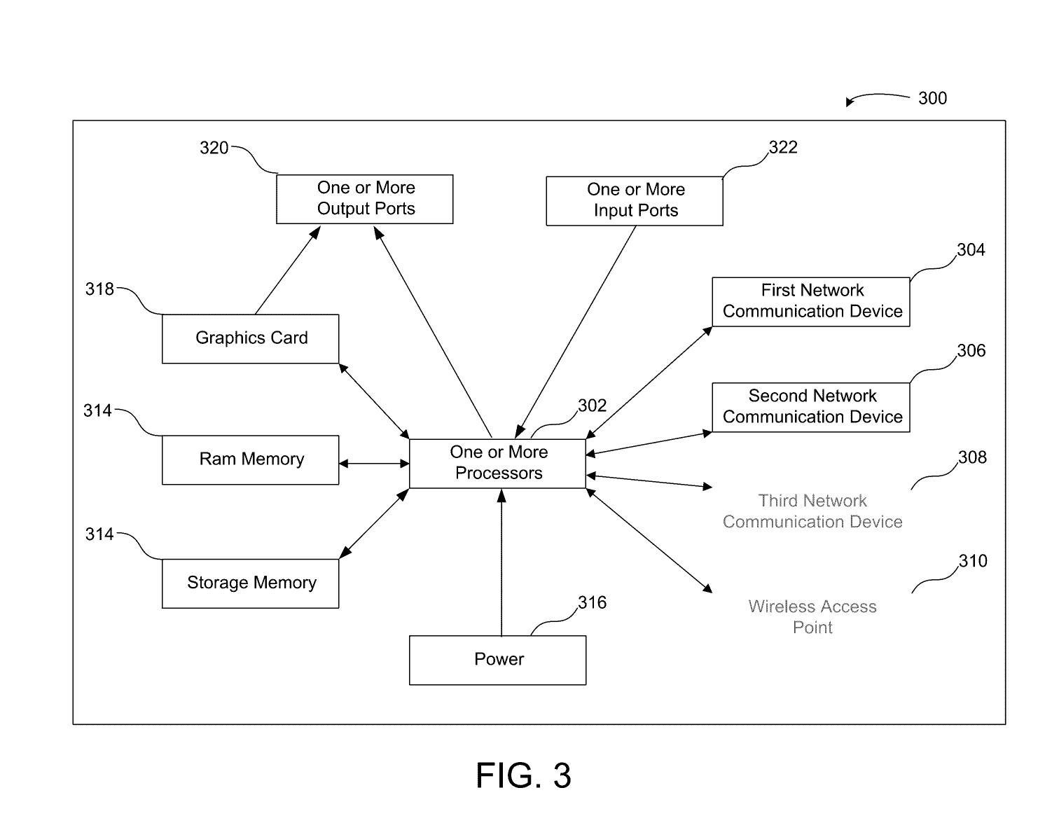

One or more of the networks 116, 118, 120 may be operatively connected to a multi-network communication box 124. The multi-network communication box 124, discussed further in reference to FIG. 3 below, may be operatively coupled to an interactive display 126 and one or more of the wired 118 or wireless networks 116, 120. In particular embodiments, the multi-network connection box 124 may be integrally formed with the interactive display 126. In various embodiments, the interactive display 126 may be an interactive whiteboard, an interactive TV, or any other suitable interactive display (e.g., a touch enabled whiteboard, a touch enabled display, etc.).

FIG. 1B is a block diagram of an alternate embodiment of a multi-network access point mirroring system 150 according to particular embodiments. Similar to the multi-network mirroring system 100 shown in FIG. 1A, the multi-network access point mirroring system 150 of FIG. 1B includes the Internet 152, a router 154, and a switch 156. The switch 156 may be operatively coupled to a wireless home network 158 and a wired home network 160 such that these networks may access the Internet 152. The networks 158, 160 may include any of a variety of types of wired or wireless computer networks such as the Internet (or other WAN), a private intranet, a mesh network, a public switch telephone network (PSTN), or any other type of network (e.g., a network that uses Bluetooth, beacon communication technologies, and/or near field communications to facilitate communication between computing devices).

The multi-network access point mirroring system 150 also includes a multi-network communication box 162 that may function as a wireless access point to one or more remote computing devices 164. The one or more remote computing devices 164 may be operatively coupled to any one of the wireless home network 158, the wired home network 160, or the multi-network communication box 162 via the wireless access point (e.g., a wireless router, a Bluetooth communication device, etc.) built into the multi-network communication box 162. The communication link between the one or more remote computing devices 164 and the wired home network 160 may be, for example, implemented via an Ethernet connection. In various embodiments, the communication link between the one or more remote computing devices 164 and the wireless home network 158 or the multi-network communication box 162 may be, for example, implemented via a wireless connection. The multi-network communication box 162 may also be operatively coupled to an interactive display 166 via a HDMI connection, a DVI connection or any other suitable connection. In various embodiments, the interactive display 166 may be an interactive whiteboard, an interactive TV, or any other suitable touch enabled display device.

FIG. 1C is a block diagram of a collaborative system 170 according to particular embodiments. As may be understood from this figure, the collaborative system 170 includes Internet 172, a router 174, and a switch 176. The switch 176 may be operatively coupled to a wired home network 178 (e.g., a corporate network, a teachers' network, etc.), and/or a wireless guest network 180 (e.g., a business guest network, a students' network, etc.) such that these networks 178, 180 may access the Internet 172. The networks 178, 180 may include any of a variety of types of wired or wireless computer networks such as the Internet (or other WAN), a private intranet, a mesh network, a public switch telephone network (PSTN), or any other type of network (e.g., a network that uses Bluetooth, beacon communication technologies, and/or near field communications to facilitate communication between computing devices). In various embodiments, one or more remote computing devices 182a, 182b may be operatively coupled to any one of the wired home network 178, or the wireless guest network 180. The communication link between the one or more remote computing devices 182a, 182b and the wired home network 178 may be, for example, implemented via an Ethernet connection. The communication link between the one or more remote computing devices 182a, 182b and the wireless home network 116 may be, for example, implemented via a wireless connection (e.g., Wi-Fi, etc.). In particular embodiments, the wired home network 178 facilitates communication between a collaboration server 184 and the one or more remote computing devices 182a, 182b. The communication link between the one or more remote computing devices 182a, 182b and the collaboration server 184 may be, for example, implemented via a Local Area Network (LAN) or via the Internet (or other WAN).

One or more of the networks 178, 180 may be operatively connected to a multi-network communication box 186. The multi-network communication box 186, discussed further in reference to FIG. 3 below, may be operatively coupled to an interactive display 188 and one or more of the wired 178 or wireless networks 180. In particular embodiments, the multi-network connection box 186 may be integrally formed with the interactive display 188. In various embodiments, the interactive display 188 may be an interactive whiteboard, an interactive TV, or any other suitable interactive display (e.g., a touch enabled whiteboard, a touch enabled display, etc.).

The collaborative system 170 of FIG. 1C allows a first user, for example, a teacher in a teaching setting or an employee in a corporate setting, to connect a remote computing device 182a, such as a tablet computer, to a wired home network 178. Because the multi-network communication box 186 is operatively coupled to the wired home network 178 and to the interactive display 188, the first user is able to mirror content from the remote computing device 182a onto the interactive display 188. A second user, for example a student, may connect a second remote computing device 182b, such as a laptop computer, to the wireless guest network 180. Because the multi-network communication box 186 is operatively coupled to the wireless guest network 180 and to the interactive display 188, the user is also able to mirror content from the remote computing device 182b onto the interactive display 188. The first and second users may display any file format onto the interactive display 188 through the multi-network communication box 186. In addition, because the multi-network communication box 186 is operatively coupled to the collaboration server 184 through the wired home network 178, the first user may set up a network with the second user through the collaboration server 184. By the first and second users connecting to the collaboration server 184, the first user is able to push slides from a presentation (as described in U.S. Published patent application Ser. No. 14/064,897 to the second user through the collaboration server 184. For files not in a native presentation format that allows editable slides to be pushed out to other users, the first user may elect to take a screenshot of the content on the interactive display 188 to send to the second user.

FIG. 1D is a block diagram of a collaborative system 190 according to particular embodiments. As may be understood from this figure, the collaborative system 190 includes one or more networks 192, a collaboration server 194, a presentation device 196, and one or more remote computing devices 198. The presentation device 196 and the one or more remote computing devices 198 may be any suitable computing device (e.g., a smart phone, a tablet computer, a wearable computing device, a laptop computer, a desktop computer, etc.). In particular embodiments, the one or more networks 192 facilitate communication between the collaboration server 194 and the one or more remote computing devices 198. The one or more networks 192 also facilitate communication between the presentation device 196 and the collaboration server 194. Thus, the one or more remote computing devices 198 and the presentation device 196 communicate with one another over the one or more networks 192 through the collaboration server 194.

The presentation device 196 may be operatively coupled to an interactive display 199. In some embodiments, the presentation device 196 may be operatively connected to the interactive display 199 by a universal serial bus (USB), Wi-Fi, Bluetooth, or any suitable wired or wireless protocol type connection. The interactive display 199 may have input/output capabilities. In various embodiments, the interactive display 199 may be an interactive whiteboard, an interactive TV, or any other suitable interactive display (e.g., a touch enabled whiteboard, a touch enabled display, etc.) such as those produced by Promethean World Plc (Promethean, Ltd.), for example that which is described in U.S. Pat. No. 8,325,162 to Promethean, Ltd., which is incorporated by reference herein in its entirety.

The collaborative presentation system 190 of FIG. 1D allows a first user, such as a teacher, to access the presentation device 196 in order to present content onto the interactive display 199. The first user may also connect the presentation device 196 to one or more networks 192 in order to access the collaboration server 194. A second user may also connect one or more remote computing devices 198, such as a laptop computer, to the one or more networks 192 in order to access the collaboration server 194. The collaborative presentation system 190 is a locally run software system on the presentation device 196 and the one or more remote computing devices 198. Similar to system described in U.S. Published patent application Ser. No. 14/064,897, the first user may show a presentation using the presentation device 196 on the interactive display 199. The presentations may be any suitable file format (e.g., a word processing document, a spreadsheet, a slide presentation, etc.). By the first and second users connecting to the collaboration server 194, the first user is able to push slides from a presentation (as described in U.S. Published patent application Ser. No. 14/064,897) to the second user through the collaboration server 194. For files not in a native presentation format that allows editable slides to be pushed out to other users, the first user may elect to take a screenshot of the content on the interactive display 199 to send to the second user to send to the second user through the collaboration server 194. In various embodiments, the system is also configured to allow the first user to create a presentation using various screenshots taken by the first user while presenting information.

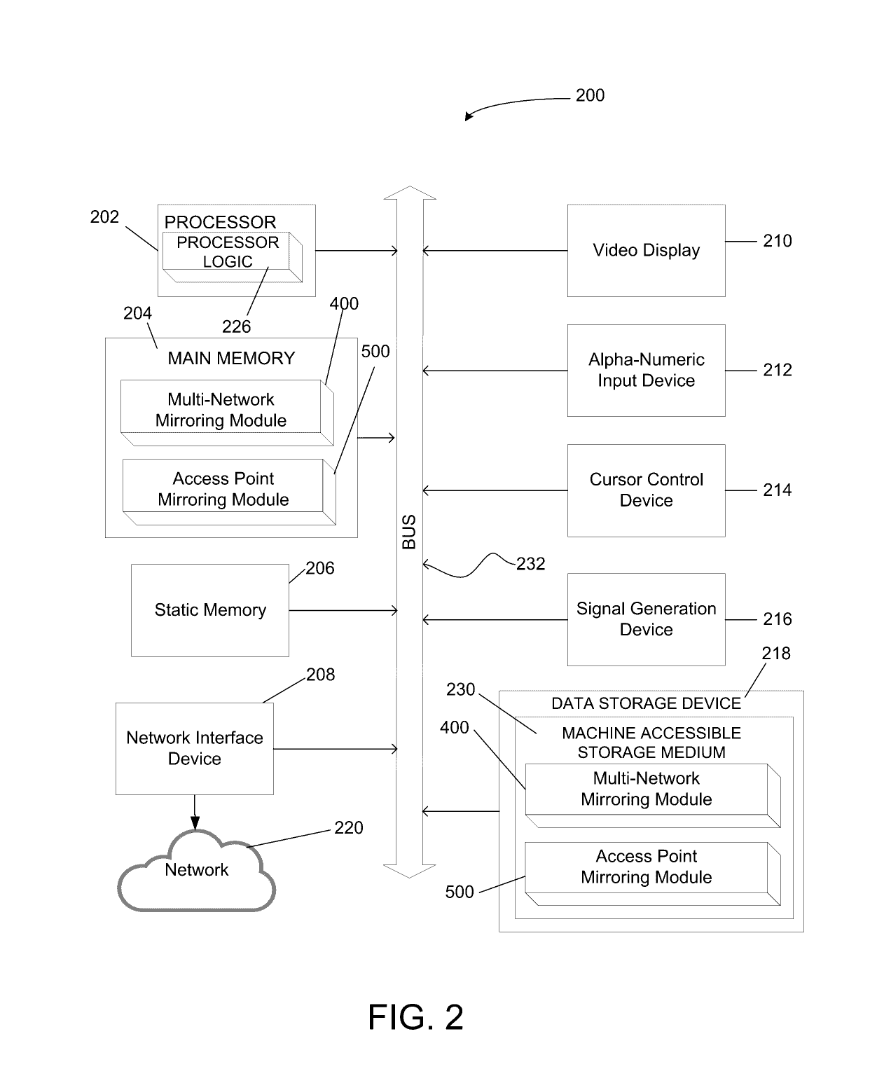

FIG. 2 illustrates a diagrammatic representation of an exemplary architecture of a computer 200 for use in various embodiments of the multi-network mirroring system 100 and/or the multi-network access point mirroring system 150. It should be understood that the computer architecture shown in FIG. 2 may represent the computer architecture for any one of the multi-network communication box 124,162, the one or more remote computing devices 122, 164, and/or the interactive display 126, 166 shown in FIGS. 1 and 2. In particular embodiments, the multi-network communication box 124, 162 may be suitable for use as a computer within the context of the multi-network mirroring system 100 and/or the multi-network access point mirroring system 150, which are configured for displaying, on a display simultaneously, information received from multiple remote computing devices connected to the multi-network communication box 124, 162 over different local area networks.

In particular embodiments, the computer 200 may be connected (e.g., networked) to other computing devices in a LAN, an intranet, an extranet, and/or the Internet as shown in FIGS. 1 and 2. As noted above, the computer 200 may operate in the capacity of a server or a client computing device in a client-server network environment, or as a peer computing device in a peer-to-peer (or distributed) network environment. The computer 200 may be a desktop personal computing device (PC), a tablet PC, a set-top box (STB), a Personal Digital Assistant (PDA), a smartphone, a web appliance, a network router, a switch or bridge, or any other computing device capable of executing a set of instructions (sequential or otherwise) that specify actions to be taken by that computing device. Further, while only a single computing device is illustrated, the term “computing device” shall also be interpreted to include any collection of computing devices that individually or jointly execute a set (or multiple sets) of instructions to perform any one or more of the methodologies discussed herein, or other suitable methodologies.

As shown in FIG. 2, an exemplary computer 200 includes a processing device 202, a main memory 204 (e.g., read-only memory (ROM), flash memory, dynamic random access memory (DRAM) such as synchronous DRAM (SDRAM) or Rambus DRAM (RDRAM), etc.), a static memory 206 (e.g., flash memory, static random access memory (SRAM), etc.), and a data storage device 218, which communicate with each other via a bus 232.

The processing device 202 represents one or more general-purpose or specific processing devices such as a microprocessor, a central processing unit (CPU), or the like. More particularly, the processing device 202 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. The processing device 202 may also be one or more special-purpose processing devices such as an application specific integrated circuit (ASIC), a field programmable gate array (FPGA), a digital signal processor (DSP), network processor, or the like. The processing device 202 may be configured to execute processing logic 226 for performing various operations and steps discussed herein.

The computer 200 may further include a network interface device 208. The computer 200 may also include a video display unit 210 (e.g., a liquid crystal display (LCD) or a cathode ray tube (CRT)), an alpha-numeric input device 212 (e.g., a keyboard), a cursor control device 214 (e.g., a mouse), a signal generation device 216 (e.g., a speaker), and a data storage device 218.

The data storage device 218 may include a non-transitory computing device-accessible storage medium 230 (also known as a non-transitory computing device-readable storage medium, a non-transitory computing device-readable medium, or a non-transitory computer-readable medium) on which is stored one or more sets of instructions (e.g., the multi-network mirroring module 400 and the access point mirroring module 500) embodying any one or more of the methodologies or functions described herein. The one or more sets of instructions may also reside, completely or at least partially, within the main memory 204 and/or within the processing device 202 during execution thereof by the computer 200—the main memory 204 and the processing device 202 also constituting computing device-accessible storage media. The one or more sets of instructions may further be transmitted or received over a network 220 via a network interface device 208.

While the computing device-accessible storage medium 230 is shown in an exemplary embodiment to be a single medium, the term “computing device-accessible storage medium” should be understood to include a single medium or multiple media (e.g., a centralized or distributed database, and/or associated caches and servers) that store the one or more sets of instructions. The term “computing device-accessible storage medium” should also be understood to include any medium that is capable of storing, encoding, or carrying a set of instructions for execution by the computing device and that causes the computing device to include any one or more of the methodologies of the present invention. The terms “computing device-accessible storage medium” and like terms should accordingly be understood to include, but not be limited to, solid-state memories, optical and magnetic media, etc.

FIG. 3 illustrates a diagrammatic representation of exemplary internal components for a multi-network communication box 300. As shown in FIG. 3, the multi-network communication box 300 includes one or more processors 302. The one or more processors 302 may represent one or more general-purpose or specific processing devices such as a microprocessor, a central processing unit (CPU), or the like. More particularly, the one or more processors 302 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. The one or more processors 302 may also be one or more special-purpose processing devices such as an application specific integrated circuit (ASIC), a field programmable gate array (FPGA), a digital signal processor (DSP), network processor, or the like. The one or more processors 302 may be configured to execute processing logic for performing various operations and steps discussed herein.

The one or more processors 302 may be operatively coupled to a first network communication device 304 and a second network communication device 306. In various embodiments, the one or more processors 302 may also be operatively coupled to a third network communication device 308. For example, the multi-network communication box 300 may include any suitable number of network communication devices. In particular embodiments, the network communication devices 304, 306 include any one of an Ethernet card, a wireless card, a wireless access card, a wireless router, etc. In various embodiments, the network communication devices 304, 306 may be any suitable communication device. In alternate embodiments, the multi-network communication box 300 may also include a wireless access point 310.

The multi-network communication box 300 also includes ram memory 312, storage memory 314, and a power source 316, which all may be directly or indirectly coupled to the one or more processors 302. In various embodiments, the one or more processors 302 may be operatively connected to a graphics card 318, which is in turn operatively connected to one or more output ports 320 (e.g., an HDMI port, a USB port, a DVI port, a VGA port, a composite video port, etc.) configured for coupling to a display such as a touch enabled display, an interactive white board or any other suitable interactive display. The multi-network communication box 300 also includes one or more input ports 322 for receiving an input device. The one or more input ports 322 may include a USB port, a Bluetooth connection, etc. In various embodiments, the multi-network communication box 300 may be configured to include drivers that allow the multi-network communication box 300 to receive and respond to touch inputs acquired by the interactive display. Thus, in various embodiments, the multi-network communication box 300 functions as a computing device that is operatively coupled to the interactive display.

### Operation of Exemplary System

As noted above, the multi-network mirroring system 100, according to various embodiments, is adapted to display information from multiple remote computing devices on a display (e.g., a touch enabled display). Various aspects of the system's functionality may be executed by certain system modules, including the multi-network mirroring module 400, which is discussed in more detail below.

Multi-Network Mirroring Module

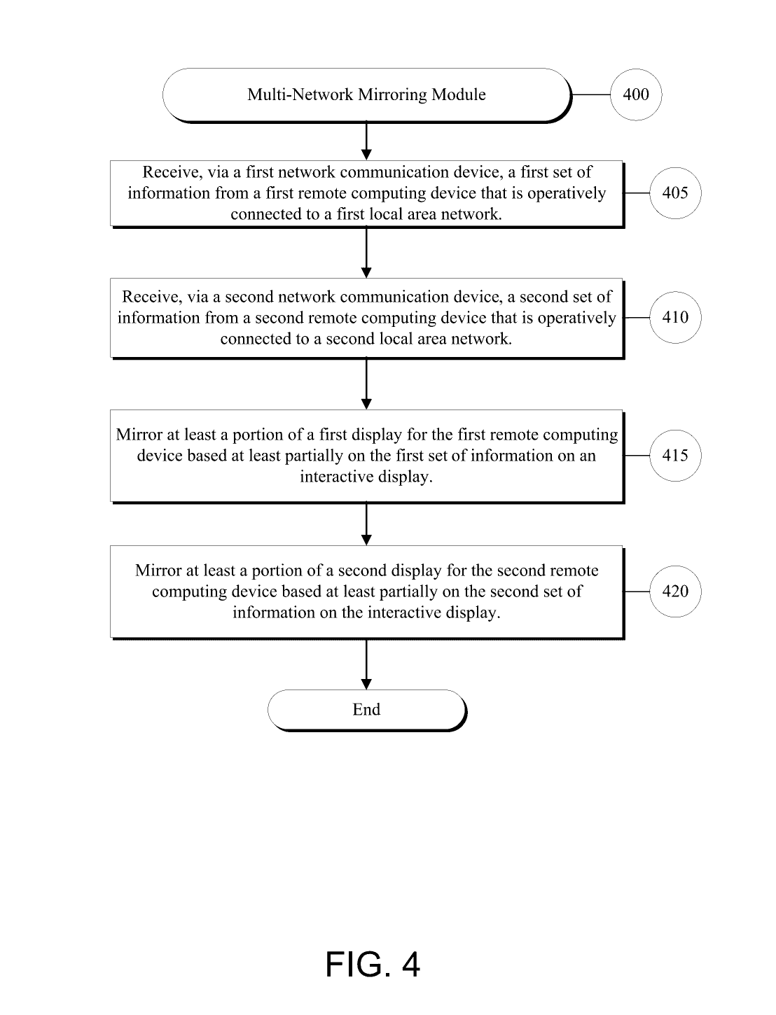

FIG. 4 illustrates a flow chart of operations performed by an exemplary multi-network mirroring module 400, which may, for example, run on the multi-network communication box 124 or any suitable computing device. In particular embodiments, the multi-network mirroring module 400 mirrors information from one or more remote computing devices onto an interactive display.

The system begins, in various embodiments, at Step 405 by receiving, via a first network communication device, a first set of information from a first remote computing device that is operatively connected to a first local area network. In various embodiments, the first network communication device may be any suitable communication device (e.g., Bluetooth device, infrared device, modem, network card using Ethernet, smartphone, Wi-Fi device, etc.). In particular embodiments, the first network communication device is a network card using Ethernet. In various embodiments, the first set of information from the first computing device includes audio and video information, and/or device information for the first computing device. In particular embodiments, the first set of information may include digital media. In various embodiments, the first computing device may be a mobile computing device.

In particular embodiments, the first local area network may be any suitable local area network. In some embodiments, the first local area network may be a home network. In various embodiments, the first local area network may be a corporate network requiring a corporate login and password to access the corporate network. In some embodiments, the first local area network may be a teacher network for teachers and faculty at a school requiring a teacher login and password to access the teacher network. In various embodiments, the first local area network is a wired network. In particular embodiments, the first local area network is a wireless network. In still other embodiments, the first local area network may be both wired and wireless.

At Step 410, the system receives, via a second network communication device, a second set of information from a second remote computing device that is operatively connected to a second local area network. In various embodiments, the second network communication device may be any suitable communication device (e.g., Bluetooth device, infrared device, modem, network card using Ethernet, smartphone, Wi-Fi device, etc.). In particular embodiments, the second network communication device is a Wi-Fi device.

In various embodiments, the second set of information from the second computing device includes audio and video information and/or device information for the second computing device. In particular embodiments, the second set of information may include digital media. In some embodiments, the second computing device may be any suitable computing device (e.g., a desktop personal computing device (PC), a tablet PC, a smartphone, etc. In various embodiments, the second computing device may be a mobile computing device.

In particular embodiments, the second local area network may be any suitable local area network. In some embodiments, the second local area network may be a guest network. In various embodiments, the second local area network may be a corporate guest network requiring a corporate guest login and password to access the corporate guest network. In some embodiments, the second local area network may be a student network for students at a school requiring a student login and password to access the student network. In various embodiments, the second local area network is a wired network. In particular embodiments, the second local area network is a wireless network.

The system, at Step 415, mirrors at least a portion of a first display for the first remote computing device based at least partially on the first set of information on an interactive display. In some embodiments, the first set of information is a first amended version of a first image. In various embodiments, suitable mirroring software can run on the multi-network communication box 124, 162 to allow for the mirroring of information from the first remote computing device onto the interactive display. Thus, any remote computing device running any particular operating system such as ANDROID®, iOS®, or WINDOWS® may mirror information onto the interactive display. In various embodiments, information from the first remote computing device can be streamed to the multi-network communication box 124, 162, which is then mirrored on the interactive display 126.

In various embodiments, the system mirrors at least a portion of a first display for the first remote computing device on a first portion of the interactive display 126. In particular embodiments, the system substantially mirrors the entire first display on the first portion of the interactive display 126. In some embodiments, the system mirrors at least a portion of the first display on the entire interactive display 126. In particular embodiments, the system mirrors the entire first display on the entire interactive display. In various embodiments, the mirrored at least a portion of the first display changes substantially simultaneously on the interactive display as the at least a portion of the first display changes on the first remote computing device. For example, when a user opens an application on the user's remote computing device, the interactive display simultaneously shows the application being opened. In particular embodiments, the system is configured to capture an image of the mirrored at least a portion of the first display. In some embodiments, the image is stored in memory for later use.

In various embodiments, the interactive display is a touch enabled display. In particular embodiments, the touch enabled display is an interactive whiteboard that is operatively coupled to one or more processors. In some embodiments, the interactive display may be used to change the display on the first remote computing device. For example, a user may move the image on the interactive display by sliding a pen along the touch enabled interactive display and, in response, the display of the user's mobile device will also move in unison with the interactive display. This allows the user to control the interactive display from either the interactive display or from the user's remote computing device.

Continuing to Step 420, the system mirrors at least a portion of a second display for the second remote computing device based at least partially on the second set of information on the interactive display. In various embodiments, the step of mirroring at least a portion of a second display for the second remote computing device occurs substantially simultaneously (e.g., simultaneously) with the step of mirroring at least a portion of the first display for the first remote computing device. In some embodiments, the second set of information is a second amended version of the first image.

In particular embodiments, the system mirrors at least a portion of the second display for the second remote computing device on a second portion of the interactive display. In various embodiments, the system substantially mirrors the entire second display on the second portion of the interactive display. In some embodiments, the system mirrors at least a portion of the second display on the entire interactive display. In particular embodiments, the system mirrors the entire second display on the entire interactive display. In various embodiments, the mirrored at least a portion of the second display changes substantially simultaneously on the interactive display as the at least a portion of the second display changes on the second remote computing device. For example, when a user opens an application on the user's mobile device, the interactive display simultaneously shows the application being opened. In particular embodiments, the system is configured to capture an image of the mirrored at least a portion of the second display. In some embodiments, the image is stored in memory for later use.

In various embodiments, the system is further configured for forming a transparent annotation layer that is positioned over at least one of the mirrored at a least a portion of the first display and the mirrored at least a portion of the second display. In particular embodiments, the system receives one or more signals via the one or more processors from the interactive display that are generated when a user touches the interactive display. In some embodiments, the system generates annotations on the transparent annotation layer at least partially in response to receiving the signals. In various embodiments, the system displays the annotations as an overlay on the transparent annotation layer.

In particular embodiments, a third local area network may be operatively connected to the one or more processors via a third communication device. In various embodiments, similar to the first local area network and the second local area network, the system receives via the third local area network a third set of information from a third remote computing device having a third display. In some embodiments, the system may mirror, via the one or more processors, at least a portion of the third display for the third remote computing device on the interactive display at least partially based on the third set of information.

### Alternate Embodiments

Access Point Mirroring Module

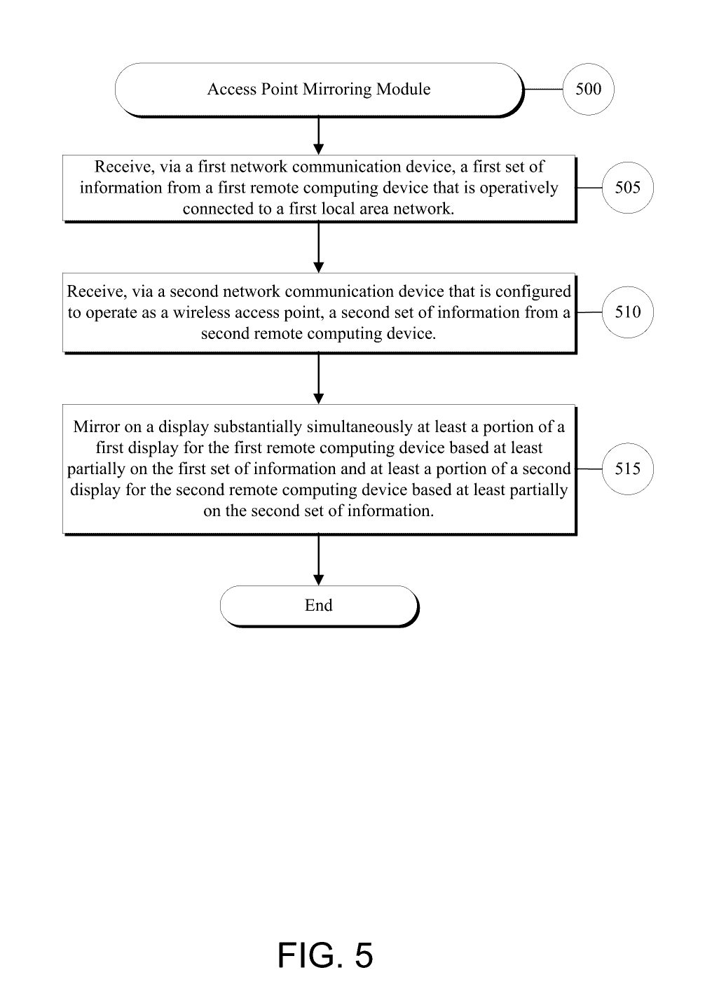

FIG. 5 depicts an alternative embodiment of the multi-network mirroring module 400 of FIG. 4. Thus, for purposes of ease of understanding and clarity, only certain parts will be discussed to highlight the differences between the access point mirroring module 500 and the multi-network mirroring module 400 shown in FIG. 4.

As noted above, in an alternate embodiment, the multi-network access point mirroring system 150, according to various embodiments, is adapted to display information from multiple remote computing devices on a display using the multi-network communication box as an access point. Various aspects of the system's functionality may be executed by certain system modules, including the access point mirroring module 500. The access point mirroring module 500 is discussed in greater detail below.

Similar to Step 405 discussed above in reference to FIG. 4, the access point mirroring module 500 of FIG. 5 begins at Step 505 by receiving, via a first network communication device, a first set of information from a first remote computing device that is operatively connected to a first local area network. In various embodiments, the first local area network may be a wireless local area network or a wired local area network. In particular embodiments, the first network communication device may include any suitable communication device (e.g., Bluetooth device, infrared device, modem, network card using Ethernet, smartphone, Wi-Fi device, etc.).

At Step 510, the system receives, via a second network communication device, a second set of information from a second remote computing device. In various embodiments, the second network communication device is configured to operate as a wireless access point. In particular embodiments, in operating as a wireless access point, the second network communication device may allow the second remote computing device to connect to a different network than the first local area network to which the first remote computing device is connected. For example, the first local area network and the wireless access point may be different local area networks. In various embodiments, the wireless access point and the first local area network may be the same network allowing different login credentials from different users. For example, the first local area network and the wireless access point may be both part of a corporate network where the first local area network allows users with corporate account information to log in and the wireless access point allows users with guest account information to log in. In particular embodiments, the system may include a third network communication device that is configured to connect to a second local area network. In various embodiments, the system may receive, via the third network communication device, a third set of information from a third remote computing device that is operatively connected to the second local area network. In some embodiments, the first local area network is a home network and the third local area network is a guest network.

Continuing to Step 515, the system mirrors on a display substantially simultaneously at least a portion of a first display for the first remote computing device based at least partially on the first set of information and at least a portion of a second display for the second remote computing device based at least partially on the second set of information. In various embodiments, the system may mirror on the display at least a portion of a third display for the third remote computing device based at least partially on the third set of information substantially simultaneously with the at least a portion of the first and second displays.

Presentation and Collaboration Module

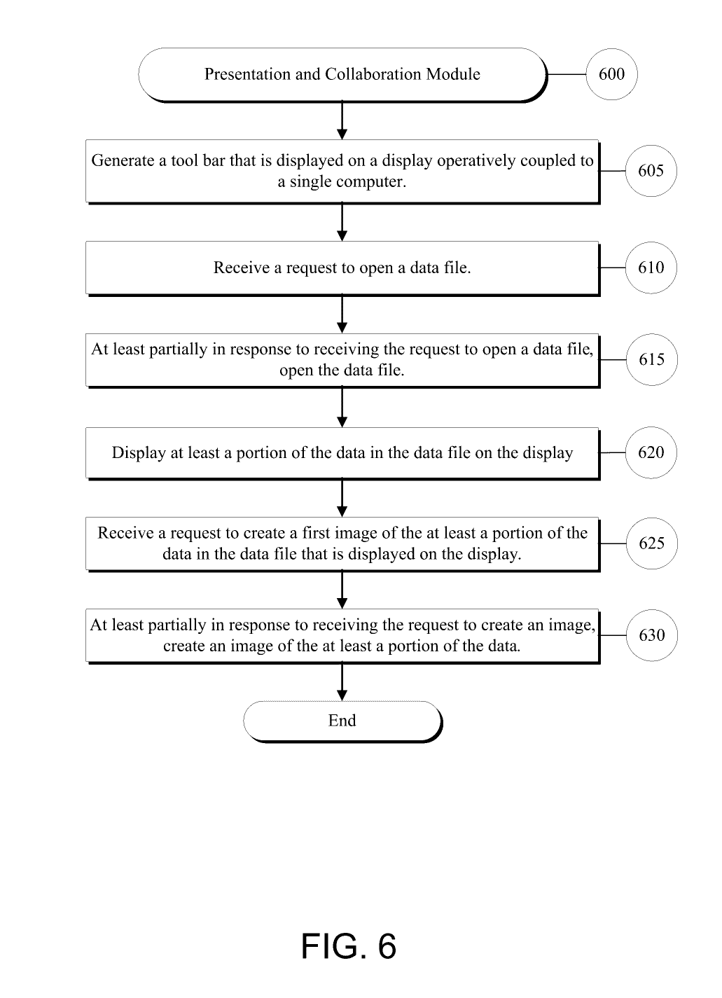

FIG. 6 illustrates a flow chart of operations performed by an exemplary presentation and collaboration module 600, which may, for example, run on the multi-network communication box 124 or any suitable computing device. In particular embodiments, the presentation and collaboration module 600 allows a user to display data on a display and to share one or more images of the displayed data with one or more users.

The system begins, in various embodiments, at Step 605 by generating a tool bar that is displayed on a display operatively coupled to a single computer. In various embodiments, the tool bar includes buttons that allow a user to select functionality selected from a group consisting of: (1) annotating on the display; (2) capturing an image of the display; (3) opening a web browser; (4) notifying a user of the single computer of third party remote computing devices coupled to the single computer; and (5) allowing a user of the single computer to operatively connect the single computer to an account associated with the user on a cloud based service. In some embodiments, the buttons of the tool bar may include any other functional button (e.g., settings, delete, edit, save, format, etc.). In particular embodiments, the tool bar may be any suitable tool bar format. In various embodiments, the tool bar is an HTML based tool bar. In some embodiments, the display may be an interactive whiteboard, an interactive TV, or any other suitable interactive display (e.g., a touch enabled whiteboard, a touch enabled display, etc.). According to various embodiments, the single computer may be coupled to a cloud based drive associated with the account of the user on the web based service.

At Step 610, the system receives a request to open a data file. In various embodiments, the data file may be any suitable data file format (e.g., PPT, DOC, PDF, HTML, etc.). In particular embodiments, the system may receive the request to open the data file by the user clicking on the particular data file located on the single computer or in a cloud based drive.

Continuing to Step 615, at least partially in response to receiving the request to open a data file, the system opens the data file. In particular embodiments, opening the data file includes: (1) sending login information to an account for a web based service; and (2) selecting a file stored in memory associated with the web based service. In various embodiments, the system opens the data file substantially automatically (e.g., automatically) in response to receiving the request to open it. In particular embodiments, the system opens the data file substantially simultaneously (e.g., simultaneously) on the single computer and the display.

At Step 620, the system displays at least a portion of the data in the data file on the display. In particular embodiments, the system displays at least a second portion of the data in the data file on the display. In various embodiments, the at least a portion of the data may include the entire data file. In particular embodiments, the at least a portion of the data may include a portion selectively outlined by the user. For example, where a data file includes two images, the user may elect to have only one of the images displayed on the display. In some embodiments, the system may be pre-programmed to display a particular portion of the data in the data file based on the type of data file. For example, where the data file is a slide presentation, the system may display each of the slides on the display but not display the notes associated with each of the slides on the display.

In particular embodiments, the single computer forms a transparent virtual layer across the display. In some embodiments, the single computer receives input from a user on the display that causes annotations to be positioned over the displayed at least a portion of the data file. In various embodiments, the input may include touch, pen, motion, mouse, etc. In some embodiments, the annotations may include adding text to the display, drawing one or more shapes over the content on the display, highlighting one or more portions of the display, etc.

The system, at Step 625, receives a request to create a first image of the at least a portion of the data in the data file that is displayed on the display. In some embodiments, the system receives a request to create a second image of at least a second portion of the data in the data file that is displayed on the display. In particular embodiments, the request may include creating a screen shot of the at least a portion of the data in the data file with any annotations currently shown. For example, if the portion of the data displayed on the display has been annotated via the transparent virtual layer, a user may request that the system create an image that includes the annotations over the portion of the data. In various embodiments, the system may receive the request to create a first image of the at least a portion of the data in the data file that is displayed on the display from the single computer, from one or more remote computing devices, from input received by the display, etc.

Continuing to Step 630, at least partially in response to receiving the request to create a first image, the system creates a first image of the at least a first portion of the data. In various embodiments, at least partially in response to receiving a request to create a second image, the system creates a second image of the at least a second portion of the data. In some embodiments, the system creates a presentation that incorporates the first image and the second image. In particular embodiments, the image created by the system may include a screenshot of the full display, a portion of the display, etc. For example, the user may use the tool bar to capture a screenshot image of only a portion of the display.

In various embodiments, the system receives a request to transmit the image to one or more remote computing devices operatively coupled with the single computer. In some embodiments, at least partially in response to receiving the request to transmit the image to the one or more remote computing devices, the system transmits the image to the one or more remote computing devices during displaying the at least a portion of the data in the data file on the display. In particular embodiments, the one or more remote computing devices may be coupled to the single computer through a cloud based service. In some embodiments, the image may be transmitted to the one or more remote computing devices through the cloud based service. In particular embodiments, the one or more remote computing devices may be operatively coupled to the single computer via a cloud based service that allows the image to be displayed on the one or more remote computing devices simultaneously while the at least a portion of the data in the data file is presented on the display.

In particular embodiments, the system stores the image of the at least a portion of the data in computer memory. In various embodiments, the data file may be stored locally on the single computer. In some embodiments, the data file may be stored in an account for a web based service associated with the user of the single computer.

### Exemplary User Experience

Corporate Application of the Multi-Network Mirroring System

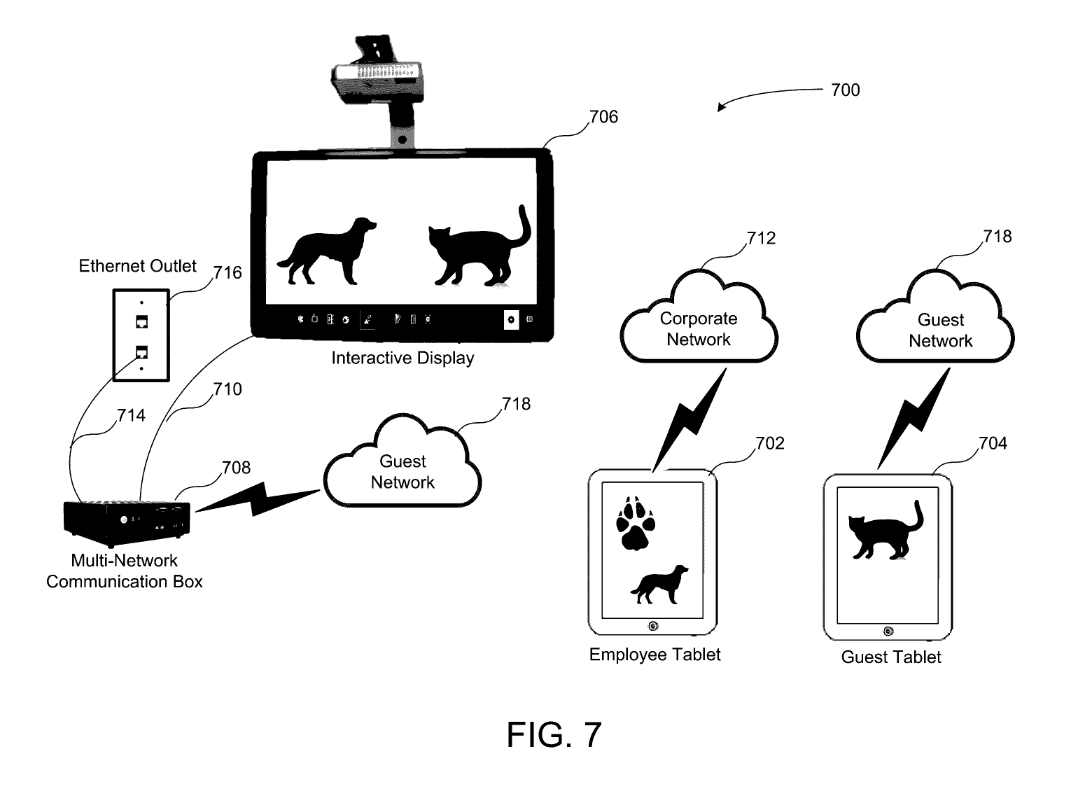

FIG. 7 depicts an exemplary multi-network mirroring system 700 according to various embodiments. The multi-network mirroring system 700 allows two users to display content from the users' remote computing devices 702, 704 onto an interactive display 706. In a particular example of a user using the multi-network mirroring system 700, a user may connect the multi-network communication box 708 to the interactive display 706 using an HDMI cable 710, for example, or any other suitable connection. The user may also connect the multi-network communication box 708 to a wired corporate network 712 by plugging an Ethernet cable 714 into the multi-network communication box 708 and connecting the Ethernet cable 714 to an Ethernet outlet 716. The user may further connect the multi-network communication box 602 to a wireless guest network 718 by using the interactive display 706 to enter credentialing information for the wireless guest network 718. The user may then plug in the AC adapter (not shown) of the multi-network communication box 708 into a plug. After all peripherals have been connected, the user may turn on the multi-network communication box 708 and use the interactive display 706 to set up the multi-network communication box 708. The multi-network communication box 708 may provide instructions on the interactive display 706 such as providing a link a user may enter on a remote computing device 702, 704 for mirroring to the interactive display 706. The instructions may also indicate that the user can connect to the interactive display 706 from a device by selecting a mirroring icon on the remote computing device 702, 704. The instructions may also include that the multi-network communication box 708 and the remote computing device 702, 704 should be connected to either the corporate network 712 or the guest network 718.

After the multi-network communication box 708 has been set up to one or more networks such as the wired corporate network 712 and the wireless guest network 718, one or more users connected to either of these networks 712, 718 may mirror content onto the interactive display 706 through the multi-network communication box 708. This may be beneficial for companies that do not want to provide guests with access to the company's home network but still need for the guest to be able to access a network to connect to the interactive display. For example, a company may invite prospective employees to interact with each other using the interactive display 706. Because the company does not want to give full access to the company's corporate network, the company may provide their guests with access to the wireless guest network 718. After a particular guest has logged into the wireless guest network 718 and the multi-network communication box 708 has been connected to the wireless guest network 718, the guest may begin mirroring content from their respective mobile devices 704 onto the interactive display 706 using the multi-network communication box 708. In addition, because the interactive display 706 is touch enabled, the guest and other users may now control the display 706 from their remote computing devices 702, 704 or from the display 706. This permits seamless mirroring and easier presentation of digital content for a larger audience. In addition, an employee using the employee tablet 702 may wish to only mirror a portion of the content on the employee tablet 702. In this case, the employee may select to mirror the bottom portion of the employee tablet 702 such that only a portion of the employee tablet screen is shown on the interactive display 706. In contrast, the guest may set up the guest tablet 704 to mirror the full screen of the guest tablet 704 onto the interactive display 706.

School Setting for Application of the Multi-Network Mirroring System

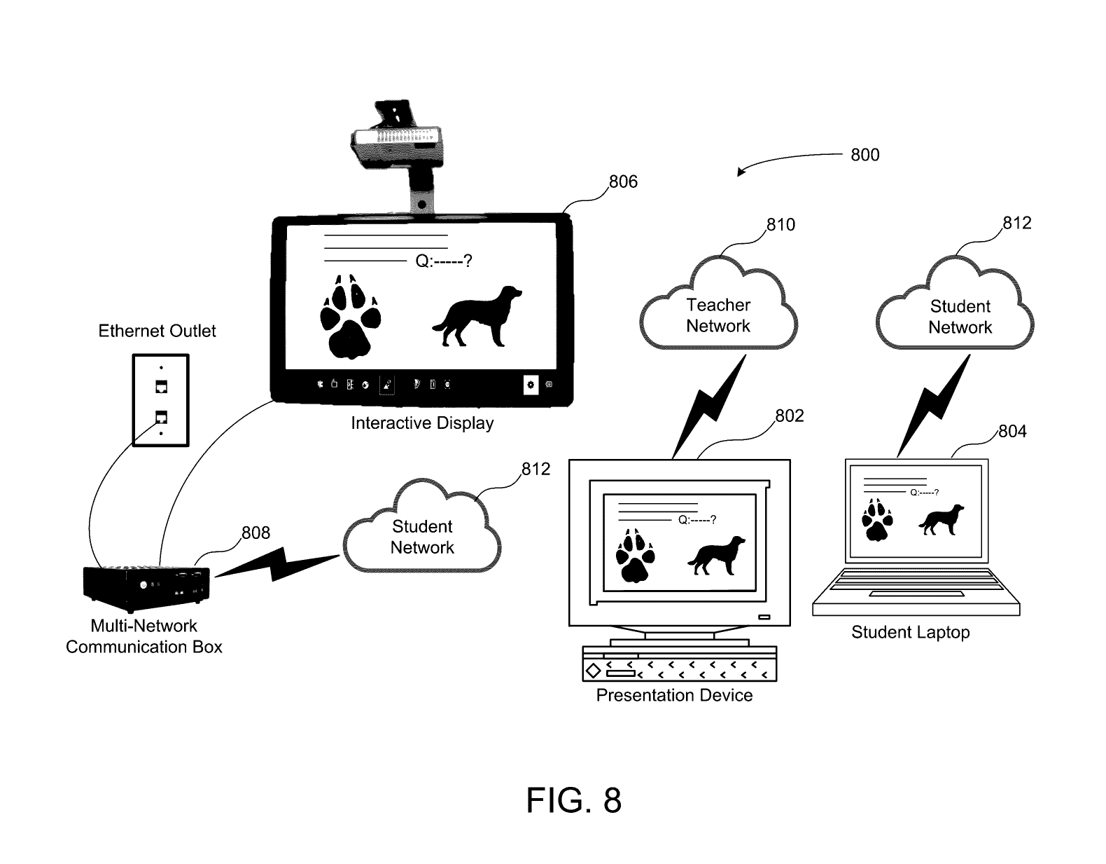

FIG. 8 depicts an exemplary multi-network mirroring collaborative system 800 according to various embodiments. The multi-network mirroring collaborative system 800 allows a first user, such as a teacher, to display content from a presentation device 802 onto a student laptop 804 and simultaneously on an interactive display 806. The multi-network mirroring collaborative system 800 is similar to the multi-network mirroring system 700 of FIG. 7. Thus, for purposes of ease of understanding and clarity, only certain parts will be discussed to highlight the differences in the structure and operation of the embodiment shown in FIG. 8 as compared to the embodiment shown in FIG. 7.

As described above in reference to FIG. 7, the user may connect the multi-network communication box 808 to the interactive display 806, to a wired teacher network 810, and to a wireless student network 812. After the multi-network communication box 808 has been set up to one or more networks such as the wired teacher network 810 and the wireless student network 812, one or more users connected to either of these networks 810, 812 may mirror content onto the interactive display 806 through the multi-network communication box 808. In the alternative, the teacher may set up the multi-network communication box 808 to only mirror content from the student laptop 804 when the teacher has granted permission for students to mirror content. This setup may be beneficial for schools that do not want to provide students with access to the school's teacher network but still need for the students to be able to access a network to connect to the interactive display 806.

In particular embodiments, a teacher may use the presentation device 802 to display slides from a presentation onto the interactive display 806. The teacher may then send out an electronically editable version of the slide to one or more students on a student laptop 804 while presenting the slides on the interactive display 806. The one or more students may receive the electronically editable version of the slide on their laptop and edit or manipulate objects in the slide, respond to questions presented on the slide, etc. Once the one or more students have completed a requested task associated with the slide, the system may be configured to receive edited versions of the slide from the student laptop 804. For example, the teacher may send out a fill-in-the-blank question that allows the student to answer a question by entering text into a field on their laptop. Once completed, the student may submit the answer for the teacher to grade or for the teacher to display on the interactive display 806 for other students to see. In other embodiments, the teacher may allow the student to mirror the contents displayed on their laptop 804 on the interactive display 806 via the multi-network communication box 808.

In various embodiments, the teacher may use the system 800 to send out non-electronically editable version of slides. For example, where the teacher has not created an electronically editable version of a slide, the teacher may capture a screenshot and send that to the one or more students. This may be beneficial where a teacher has information for the students that was not in the original lesson plan and must be included on the fly.

Interactive Application of the Collaborative System

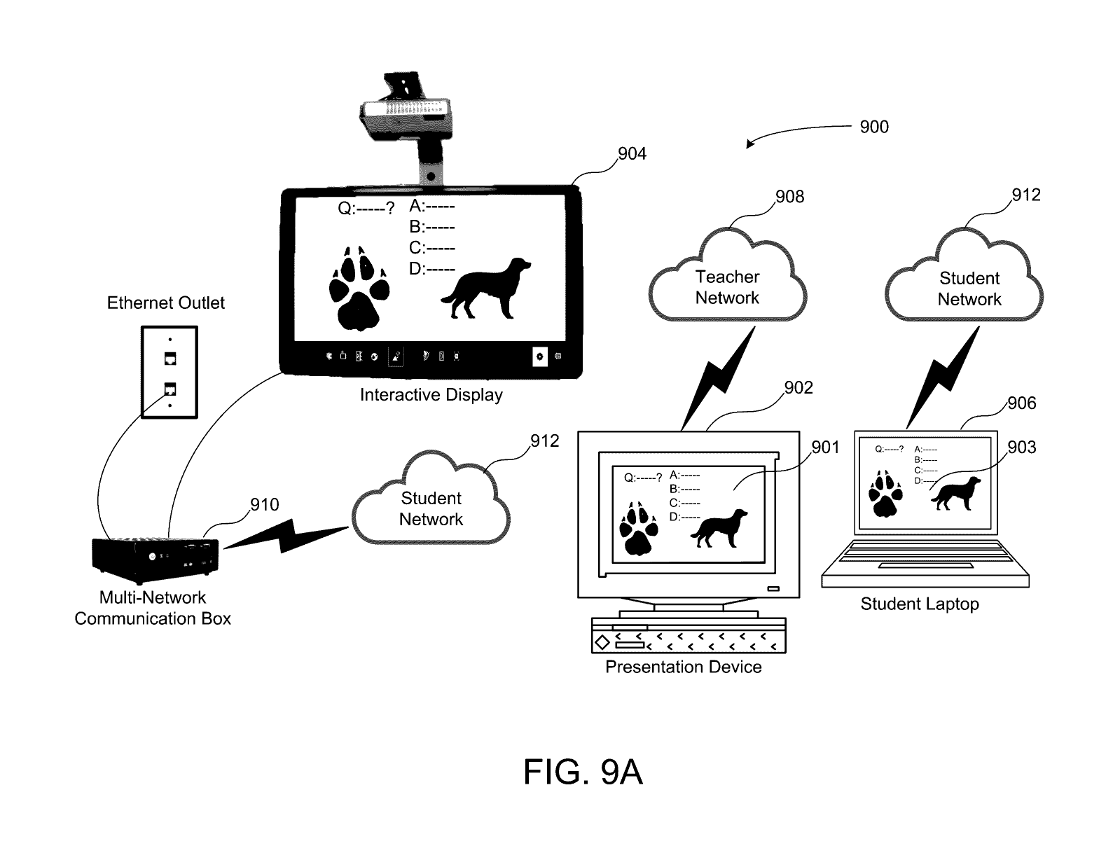

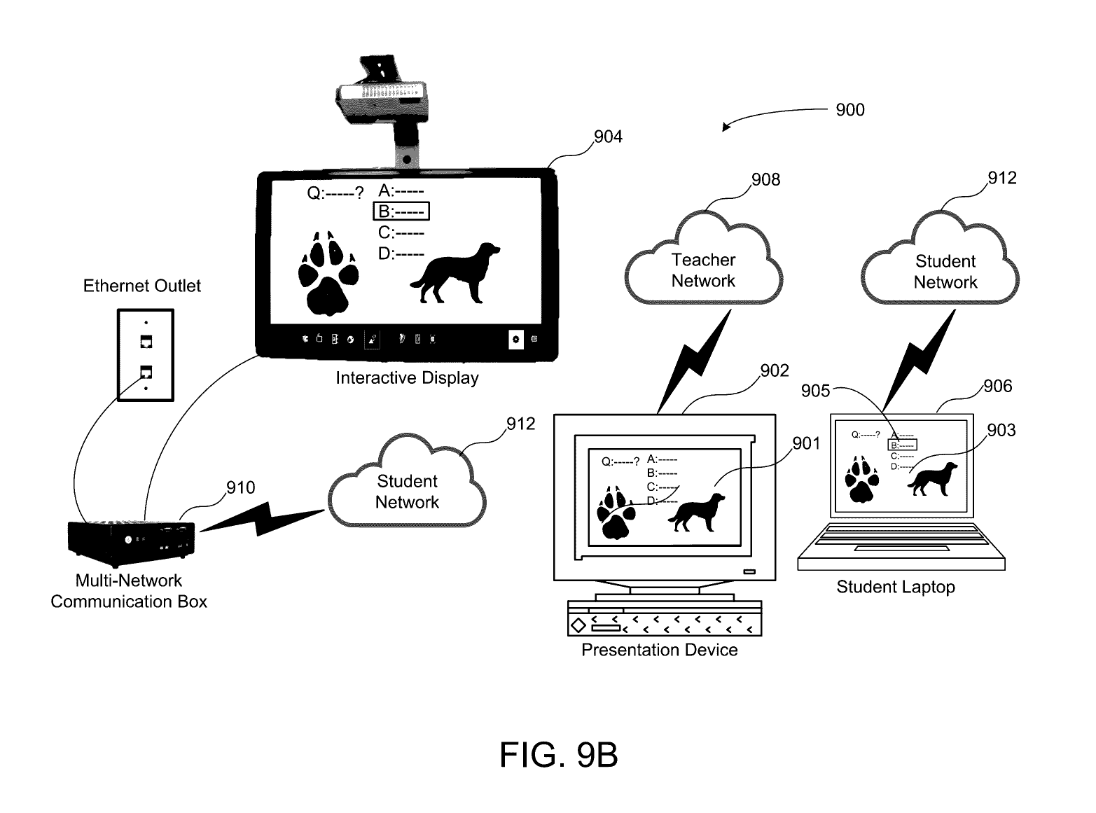

FIGS. 9A and 9B depict an exemplary collaborating system 900 according to various embodiments. The collaborating system 900 allows a first user, such as a teacher, to display content 901 from a presentation device 902 onto an interactive display 904, and transmit a screenshot 903 from the interactive display 904 to a student laptop display 906. The collaborating system 900 also allows a second user, such as a student, to annotate over the screenshot 903 received from the teacher and transmit the annotated screenshot back to the interactive display 904. The collaborating system 900 is similar to the multi-network mirroring system 700 of FIG. 7 and the multi-network mirroring collaborative system 800 of FIG. 8. Thus, for purposes of ease of understanding and clarity, only certain parts will be discussed to highlight the differences in the structure and operation of the embodiment shown in FIGS. 9A and 9B as compared to the embodiments shown in FIGS. 7 and 8.

As shown in FIG. 9A, the first user, such as a teacher, may mirror content 901 from the presentation device 902 onto the interactive display 904 while the presentation device 902 is connected to a teacher network 908. The teacher network 908 may be connected to a multi-network communication box 910 through Ethernet. Connecting to the multi-network communication box 910 through the teacher network 908 allows the first user (e.g., a teacher, etc.) to present content such as a question to a classroom of students. The multi-network communication box 910 also allows the first user to take a screenshot 903 of the content 901 to transmit to the student laptop 906. As shown in FIG. 9A, because the first user has transmitted the screenshot 903 to the student laptop 906, each of the student laptop display 906, the interactive display 904, and the presentation device 902 are displaying the same content (i.e., the teacher's question with a set of answer choices).

Continuing to FIG. 9B, the second user, such as the student, may annotate the screenshot (e.g., add text to the screenshot, draw one or more shapes over the content of the screenshot, highlight one or more portions of the screenshot, etc.). For example, the second user may select an answer choice from the teacher's set of answer choices by drawing a shape 905 around the selected answer. Once an annotation has been made, the second user may mirror the content from the student laptop 906 onto the interactive display 904 via the student network 912, which is connected wirelessly to the multi-network communication box 910.

### Conclusion

Many modifications and other embodiments of the invention will come to mind to one skilled in the art to which this invention pertains, having the benefit of the teaching presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

What is claimed:

1. A non-transient computer readable medium containing program instructions for causing a single computer to perform a method of:
a. generating a tool bar that is displayed on a display operatively coupled to the single computer, wherein the tool bar comprises buttons that allow a user to select functionality selected from a group consisting of:
i. annotating on the display,
ii. capturing an image of the display,
iii. opening a web browser,
iv. notifying a user of the single computer of third party remote computing devices coupled to the single computer; and
v. allowing a user of the single computer to operatively connect the single computer to an account associated with the user on a cloud based service;
b. receiving a request to open a data file;
c. at least partially in response to receiving the request to open the data file, opening the data file;
d. displaying at least a portion of the data in the data file on the display;
e. receiving a request to create a duplicate of the at least a portion of the data in the data file that is displayed on the display;
f. at least partially in response to receiving the request to create an image, creating an image of the at least a portion of the data; and
g. storing the image in memory.

2. The non-transient computer readable medium of claim 1, wherein the tool bar is an HTML based toolbar.

3. The non-transient computer readable medium of claim 1, wherein the data file is stored locally on the single computer.

4. The non-transient computer readable medium of claim 1, wherein the data file is stored in an account for a web based service associated with the user of the single computer.

5. The non-transient computer readable medium of claim 1, wherein opening the data file further comprises:
a. sending login information to an account for a web based service; and
b. selecting a file stored in memory associated with the web based service.

6. The non-transient computer readable medium of claim 5, wherein the program instructions are further configured for causing the single computer to couple to a cloud based drive associated with the account of the user on the web based service;

7. The non-transient computer readable medium of claim 1, wherein the program instructions are further configured for causing the single computer to:
a. form a transparent virtual layer across the display; and
b. receive input from a user on the display that causes annotations to be positioned over the displayed at least a portion of the data file.

8. The non-transient computer readable medium of claim 1, wherein the program instructions are further configured for causing the single computer to:
a. receive a request to transmit the image to one or more remote computing devices operatively coupled with the single computer; and
b. at least partially in response to receiving the request to transmit the image to the one or more remote computing devices, transmit the image to the one or more remote computing devices during displaying the at least a portion of the data in the data file on the display.

9. The non-transient computer readable medium of claim 8, wherein the one or more remote computing devices are coupled to the single computer through a cloud based service.

10. The non-transient computer readable medium of claim 9, wherein the image is transmitted to the one or more remote computing devices through the cloud based service.

11. A system for allowing a user to display data on a display and to share one or more images of the displayed data with one or more users, the system comprising:
a. a single computer having one or more processors;
b. a display operatively coupled to the single computer; and
c. memory operatively coupled to the one or more processors, wherein the single computer is configured for:
i. receiving a request to open a data file;
ii. at least partially in response to receiving the request to open a data file, opening the data file;
iii. displaying at least a portion of the data in the data file on the display;
iv. receiving a request to create a duplicate of the at least a portion of the data in the data file that is displayed on the display;
v. at least partially in response to receiving the request to create an image, creating an image of the at least a portion of the data;
vi. receiving a request to transmit the image to one or more remote computing devices operatively coupled with the single computer; and
vii. at least partially in response to receiving the request to transmit the image to the one or more remote computing devices, transmitting the image to the one or more remote computing devices during displaying the at least a portion of the data in the data file on the display.

12. The system of claim 11, wherein the one or more remote computing devices are operatively coupled to the single computer via a cloud based service that allows the image to be displayed on the one or more remote computing devices simultaneously while the at least a portion of the data in the data file is presented on the display.

13. The system of claim 11, further comprising:
a. a first network communication device that is configured to connect to a first local area network; and
b. a second network communication device that is configured to operate as a wireless access point that can wirelessly connect to the one or more remote computing devices that are local to the second network communication device, wherein the system is further configured for transmitting the image to the one or more remote computing devices via the second network communication device;

14. The system of claim 13, wherein the system is further configured for:
a. receiving, via the first network communication device, a first set of information from a first remote computing device that is operatively connected to the first local area network;
b. receiving, via the second network communication device, a second set of information from a second remote computing device;
c. mirroring on the display at least a portion of a first display for the first remote computing device based at least partially on the first set of information; and
d. mirroring on the display at least a portion of a second display for the second remote computing device based at least partially on the second set of information.

15. The system of claim 14, wherein mirroring at least a portion of the first display and the second display occurs substantially simultaneously.

16. The system of claim 14, wherein the first set of information is a first amended version of the first image and the second set of information is a second amended version of the first image.

17. The system of claim 14, wherein the system is further configured for:
a. forming a transparent annotation layer that is positioned over at least one of the mirrored at least a portion of the first display and the mirrored at least a portion of the second display;
b. receiving signals via the one or more processors that are generated when a user inputs annotations on the display;
c. generating annotations on the transparent annotation layer at least partially in response to receiving the signals; and
d. displaying the annotations as an overlay on the transparent annotation layer.

18. The system of claim 13, wherein
a. the first local area network is selected from a group consisting of:
i. a teacher network; and
ii. a corporate network; and
b. the second local area network is selected from a group consisting of:
i. a student network; and
ii. a guest network.

19. A method for allowing a user to display data on a display and to share one or more images of the displayed data with one or more users, the system comprising:
a. generating a tool bar that is displayed on a display operatively coupled to a single computer, wherein the tool bar comprises buttons that allow a user to select functionality selected from a group consisting of:
i. annotating on the display,
ii. capturing an image of the display,
iii. opening a web browser,
iv. notifying a user of the single computer of third party remote computing devices coupled to the single computer; and
v. allowing a user of the single computer to operatively connect the single computer to an account associated with the user on a cloud based service;
b. receiving a request to open a data file;
c. at least partially in response to receiving the request to open a data file, opening the data file;
d. displaying at least a first portion of the data in the data file on the display;
e. receiving a request to create a first image of the at least a first portion of the data in the data file that is displayed on the display;
f. at least partially in response to receiving the request to create a first image, creating a first image of the at least a first portion of the data;
g. displaying at least a second portion of the data in the data file on the display;
h. receiving a request to create a second image of the at least a second portion of the data in the data file that is displayed on the display;
i. at least partially in response to receiving the request to create a second image, creating a second image of the at least a second portion of the data; and
j. creating a presentation that incorporates the first image and the second image.

20. The method of claim 19, wherein the display is a touch enabled display.
